(19) United States
(12) Patent Application Publication
(10) Pub. No.: US 2007/0257381 A1
(43) Pub. Date: Nov. 8, 2007

(54) Cavitation generating system

(76) Inventor: Shuo Wei Chuang, Taipei (TW)

Correspondence Address: BACON & THOMAS, PLLC, 625 SLATERS LANE, FOURTH FLOOR, ALEXANDRIA, VA, 22314, US

(21) Appl. No.: 11/429,152

(22) Filed: May 8, 2006

(51) Int. Cl. B01F 3/04

(52) U.S. Cl. 261/76; 261/DIG. 75

(57) ABSTRACT

A cavitation-like generating system includes a venturi tube, a pump for pumping water through the venturi tube, an air compressor for providing a compressed gas into the venturi tube to mix with water being pumped into the venturi tube, an accumulation tank for buffering the flow of air-water mixture coming out of the pump for output through a water outlet pipe, and a reduction valve for reducing the pressure of the output flow of air-water mixture through the water outlet pipe.

### BACKGROUND OF THE INVENTION

1. Field of the Invention

The present invention is a device which air is introduced before pump to create a cavitation-like condition where water-gas is well mixed. It includes a venturi-tube and/or an air compressor, a pump, an accumulation tank, and a reduction valve. The venturi tube and/or air compressor is connected to the pump, the later is connected to the accumulation tank with the reduction valve. And by regulating the air in-take and the reduction valve, a cavitation-like condition is produced. Because of the high speed of the pump, the pressure so created forces a greater amount of air to dissolve in water and greater amount of micro bubbles, or even much smaller in size are produced. The present invention can be used in cleaning, sterilization, floatation, fermentation, irrigation, aquaculture, and other water-treatment industries.

2. Description of the Related Art

Various mechanical and electronic bubble generating apparatus are known. An electronic bubble generating apparatus uses an ultrasonic vibrator to generate high-frequency vibrating waves, thereby producing bubbles in water. FIG. 1 illustrates a conventional mechanical bubble generating system. This design of bubble generating system comprises a water tank 60, a mixing tank 70 connected to the water tank 60, a water pump 30 adapted to pump water out of the water tank 60 into the mixing tank 70, and an air compressor 50 adapted to provided a compressed air into the mixing tank 70 to mix with water returned to the water tank 60. This design of bubble generating system is still not satisfactory in function.

### SUMMARY OF THE INVENTION

The present invention has been accomplished under the circumstances in view. It is the main object of the present invention to provide a cavitation-like generating system, which causes a cavitation-like condition to impact water, thereby producing micro and/or nano air bubbles in water.

According to one aspect of the present invention, the cavitation-like system comprises a veutri tube (negative pressure), and/or a compressed air (positive pressure). The veturi-tube, having one end connected to a water source (a water inlet pipe), the other end is connected to compresed air (or compressed air alone connected directly to water source) if positive pressure is required. A pump adapted to pump in the water-air mixture from the said inlet pipe. Through the high speed of pump and pressure so created, the water-air mixture, the air further impacts with water, and forces greater amount of air to disove in water and greater amount of micro air bubble, or ever much smaller in size of air bubbles are produced. The pump then discharges the air-water mixture into a accumulation tank to stablize the mixture. The accumulation tank having the input side connected to pump, the out-put side is connected to a reduction valve.

By regulating the amount of air intake and the slit of the reduction value, a cavitation-like condition is generated. The right adjustment will never generate cavitation, and a nearly cavitation condition will be able to maintain and the pump will never fail.

### BRIEF DESCRIPTION OF THE DRAWINGS

FIG. 1 is an elevational view of a bubble generating system according to the prior art.

FIG. 2 is an elevational view of a cavitation-like generating system according to the present invention.

FIG. 3 is a system block diagram of the cavitation-like generating system according to the present invention.

FIG. 4 is a sectional view of a part of the present invention, showing the structure of the venturi tube.

FIG. 5 is a sectional view of a part of the present invention, showing the structure of the reduction valve.

FIG. 6 is a schematic drawing showing the cavitation-like generating system in operation.

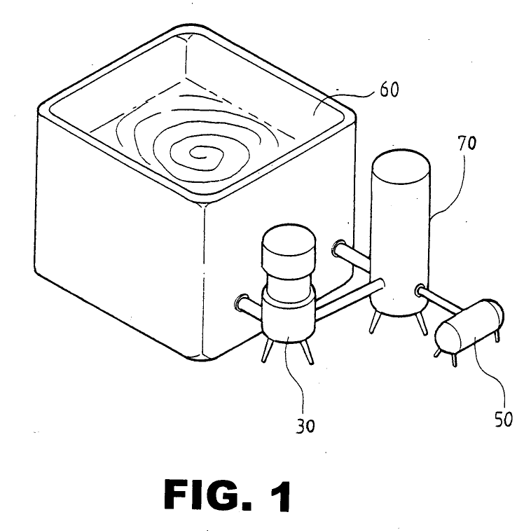

### DETAILED DESCRIPTION OF THE PREFERRED EMBODIMENT

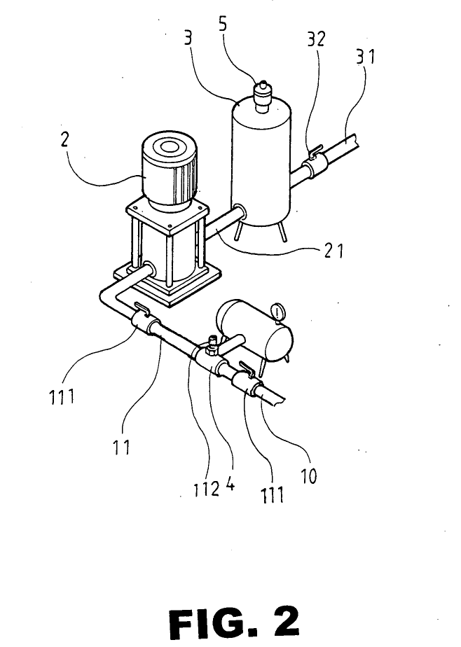

Referring to FIGS. 2˜5, a cavitation-like generating system in accordance with the present invention is shown comprising an air compressor 1, a pump 2, an accumulation tank 3, a reduction value 32 and a venturi tube 4. The air compressor 1 and the venturi tube 4 are connected in parallel between a water inlet pipe 10 and a first water delivery pipe 11. The first water delivery pipe 11 has one end connected to the air compressor 1 and the venturi tube 4 and the other end connected to the input side of the pump 2. Further, two control valve 111 are placed before and after venturi tube. A gas regulator 112 is provided at venturi tube. The pump 2 has the output side thereof connected to the accumulation tank 3 through a second water delivery pipe 21. The accumulation tank 3 is provided with a relief valve 5 at the top, having a water outlet pipe 31 for water output. The water outlet pipe 31 is provided with a reduction valve 32.

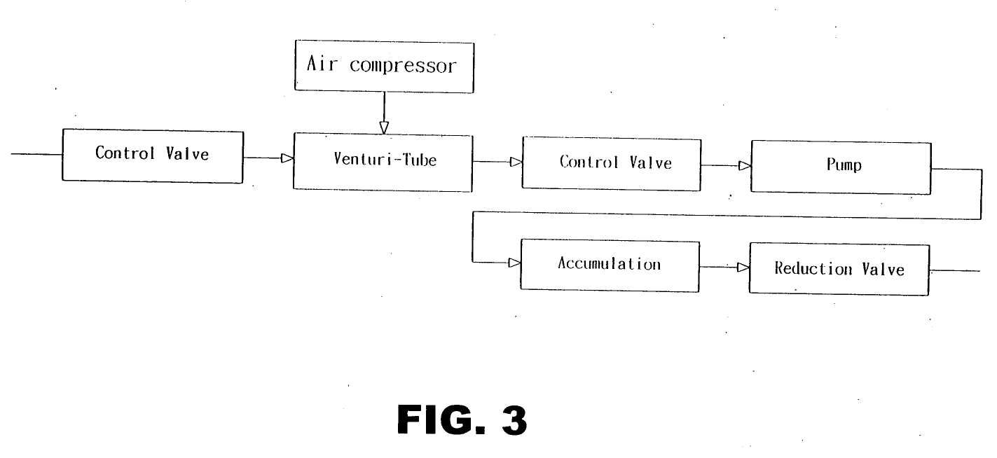

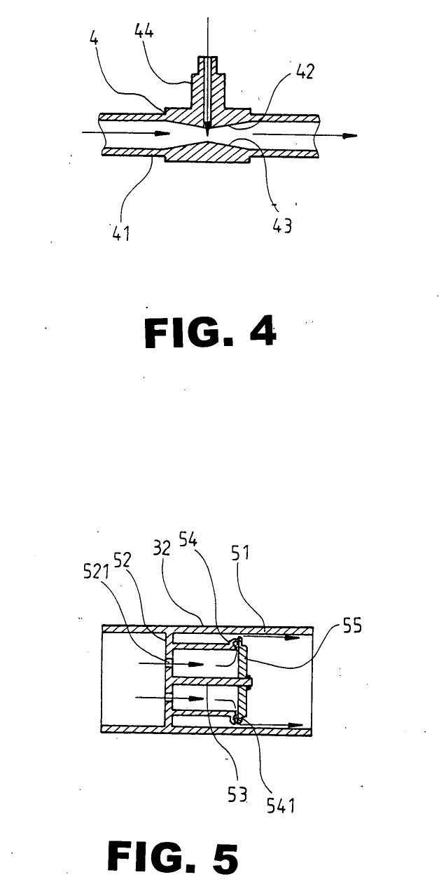

Referring to FIG. 4 and FIGS. 2 and 3 again, the venturi tube 4 comprises a main tube body 41, a venturi section 42 formed on the main tube body 41 and constricted in the middle and flared 43 on both ends, and connection tube body 44 perpendicularly outwardly extending from the constricted middle of the venturi section 42 and connected to the air compressor 10.

Referring to FIG. 5 and FIGS. 2 and 3 again, the reduction valve 32 comprises tubular casing 51, a transverse partition wall 52 formed inside the tubular casing 51, a plurality of through holes 521 extending through the transverse partition wall 52, a screw rod 53 perpendicularly connected to the center of one side of the transverse partition wall 52, a barrel 54 fixedly connected to one side of the transverse partition wall 52 around the screw rod 53, and a cap 55 fastened to the distal end of the screw rod 53 and capped on the barrel 54. Further, the barrel 54 has a grooved flange 541 disposed in contact with the cap 55 and defining with the cap 55 a gap for the flowing of water that passes through the through holes 521.

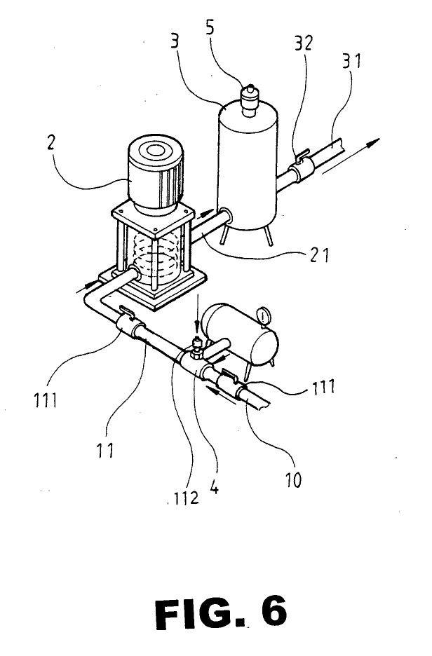

Referring to FIG. 6, when the cavitation-like generating system is in operation, with (positive pressure) or without (negative pressure) the air compressor 1, it provides air through the venturi tube 4 into the inlet pipe 10 forming an air-water mixture toward the pump 2. Being at high speed and high pressure generated, the pump 2 further impacts the air-water mixture to micro or even smaller air bubbles and them dischanges this mixture into accumulation tank 3. The air-water mixture in the accumulation tank 3 is then forced out of the accumulation tank 3 through the water outlet pipe 31. When water is forced out of the accumulation tank 3 through the water outlet pipe 31, the reduction valve 32 reduces the pressure of the output flow of water. Because the water so produced carries huge number of bubbles, and higher concentration of dissolved air in water, it is effective in use for cleaning, sterilization, floatation, fermentation, irrigation, aquaculture and other water treatment industries.

Although a particular embodiment of the invention has been described in detail for purposes of illustration, various modifications and enhancements may be made without departing from the spirit and scope of the invention.

What the invention claimed is:

1. A cavitation-like generating system comprising:
a venturi tube, said venturi tube having an input end connected to a water source through a water inlet pipe and an output end;
an air compressor connected to said venturi tube or direct to inlet tube and adapted to provide a compressed gas into said venturi tube toward the output end of said venturi tube;
a pump adapted to pump in water from said water inlet pipe for mixing with said compressed gas, said pump having an input port connected to the output end of said venturi tube and an output end; to
an accumulation tank, said accumulation tank having an input side connected to the output port of said pump and an output side connected to a water outlet pipe.

2. The cavitation-like generating system as claimed in claim 1, further claims that, by introducing air before the pumping system, which is abnormal way of using a pump, is a state of art for the present invention, by regulating the amount of air intake and the slit size of reduction valve, a cavitation-like condition can be maintained where greater amount of air dissolved in water and huge number of micro or even smaller air bubbles are generated.
